(19) United States
(12) Patent Application Publication
(10) Pub. No.: US 2024/0322516 A1
(43) Pub. Date: Sep. 26, 2024

(54) OPTICAL FIBER AMPLIFIER AND RARE-EARTH ELEMENT DOPED MULTICORE OPTICAL FIBER

(71) Applicant: SUMITOMO ELECTRIC INDUSTRIES, LTD., Osaka (JP)

(72) Inventor: Takafumi OHTSUKA, Osaka (JP)

(21) Appl. No.: 18/608,073

(22) Filed: Mar. 18, 2024

(30) Foreign Application Priority Data
Mar. 23, 2023 (JP) 2023-047138

(51) Int. Cl. H01S 3/067; H01S 3/23

(52) U.S. Cl. CPC H01S 3/06716; H01S 3/06737; H01S 3/2316

(57) ABSTRACT

An optical fiber amplifier includes a first rare-earth element doped optical fiber including a first region including a center of a first core configured to guide signal light, a second region surrounding the first region and doped with a rare-earth element, and a third region surrounding the second region. The optical fiber amplifier includes a second rare-earth element doped optical fiber provided on a signal output-side of the first rare-earth element doped optical fiber, the second rare-earth element doped optical fiber including a fourth region including a center of a second core configured to guide the signal light, and the fourth region being doped with the rare-earth element. The second rare-earth element doped optical fiber includes a fifth region surrounding the fourth region, and includes a sixth region surrounding the fifth region.

### CROSS-REFERENCE TO RELATED APPLICATIONS

This application claims priority of Japanese Patent Application No. 2023-47138, filed on Mar. 23, 2023, the entire contents of which are incorporated herein by reference.

### TECHNICAL FIELD

The present disclosure relates to an optical fiber amplifier and a rare-earth element doped multicore optical fiber.

### BACKGROUND

Each of Non-Patent Document 1 and Non-Patent Document 2 describes a method of increasing density of a core surrounded by a first cladding that confines pump light, in order to reduce optical pump power for each core in a multicore optical fiber amplifier with a cladding pumped configuration.

Each of Patent Document 1 and Non-Patent Document 3 discloses a rare-earth doped multicore optical fiber amplifier in which a ring region is doped with rare-earth in a rare-earth doped optical fiber.

### PRIOR ART DOCUMENT

### Patent Document

[Patent Document 1] U.S. Pat. No. 6,288,835

### Non-Patent Document

[Non-Patent Document 1] S. Takasaka et al., “EDF Length Dependence of Amplification Characteristics of Cladding Pumped 19-Core EDFA”, 2018 Optical Fiber Communications Conference and Exposition (OFC), San Diego, CA, USA, 2018, pp. 1-3.
[Non-Patent Document 2] M. Wada, T. Sakamoto, S. Aozasa, R. Imada, T. Yamamoto and K. Nakajima, “Full C-Band and Power Efficient Coupled-Multi-Core Fiber Amplifier”, 2020 Optical Fiber Communications Conference and Exhibition (OFC), San Diego, CA, USA, 2020, pp. 1-3.
[Non-Patent Document 3] S. LaRochelle, C. Matte-Breton, C. Kelly and R. J. Essiambre, “Cladding-pumped multicore amplifiers with ring doping”, 2021 Optical Fiber Communications Conference and Exhibition (OFC), San Francisco, CA, USA, 2021, pp. 1-3.

### SUMMARY

An optical fiber amplifier in the present disclosure includes a first rare-earth element doped optical fiber including a first region including a center of a first core configured to guide signal light, a second region surrounding the first region and doped with a rare-earth element, and a third region surrounding the second region. The optical fiber amplifier includes a second rare-earth element doped optical fiber provided on a signal output-side of the first rare-earth element doped element optical fiber, the second rare-earth element doped optical fiber including a fourth region including a center of a second core configured to guide the signal light, and the fourth region being doped with the rare-earth element. The second rare-earth element doped optical fiber includes a fifth region surrounding the fourth region and a sixth region surrounding the fifth region.

### BRIEF DESCRIPTION OF THE DRAWINGS

FIG. 1 is a diagram showing the outline of an optical fiber amplifier according to a first embodiment.

FIG. 2 is a cross-sectional view of a schematic structure of a first rare-earth element doped optical fiber in the optical fiber amplifier according to the first embodiment.

FIG. 3 is a cross-sectional view of a schematic structure of a second rare-earth element doped optical fiber in the optical fiber amplifier according to the first embodiment.

FIG. 4 is a diagram for describing an operation result of the optical fiber amplifier according to the first embodiment.

FIG. 5 is a diagram for describing the operation result of the optical fiber amplifier according to the first embodiment.

FIG. 6 is a diagram showing the outline of the optical fiber amplifier according to a second embodiment.

FIG. 7 is a cross-sectional view of a schematic structure of the first rare-earth element doped optical fiber in the optical fiber amplifier according to the second embodiment.

FIG. 8 is a cross-sectional view of a schematic structure of the second rare-earth element doped optical fiber in the optical fiber amplifier according to the second embodiment.

FIG. 9 is a cross-sectional view of a schematic structure of the first rare-earth element doped optical fiber in the optical fiber amplifier according to a modified second embodiment.

FIG. 10 is a cross-sectional view of a schematic structure of the second rare-earth element doped optical fiber in the optical fiber amplifier according to the modified second embodiment.

FIG. 11 is a diagram showing the outline of the optical fiber amplifier according to a third embodiment.

FIG. 12 is a cross-sectional view of a schematic structure of the first rare-earth element doped optical fiber in the optical fiber amplifier according to the third embodiment.

FIG. 13 is a cross-sectional view of a schematic structure of the second rare-earth element doped optical fiber in the optical fiber amplifier according to the third embodiment.

FIG. 14 is a cross-sectional view of a schematic structure of the first rare-earth element doped optical fiber in the optical fiber amplifier according to a modified third embodiment.

FIG. 15 is a cross-sectional view of a schematic structure of the second rare-earth element doped optical fiber in the optical fiber amplifier according to the modified third embodiment.

### DETAILED DESCRIPTION

### Problem to be Solved by the Present Disclosure

In optical fiber amplifiers, it is required to increase power efficiency and reduce noise figure.

The present disclosure provides an optical fiber amplifier with higher power efficiency and lower noise figure.

### Effects of the Present Disclosure

In the present disclosure, power efficiency can be increased and noise figure can be reduced.

### Description of Embodiments in the Present Disclosure

First, embodiments of the present disclosure will be listed and described as follows.

(1) An optical fiber amplifier in the present disclosure includes a first rare-earth element doped optical fiber and a second rare-earth element doped optical fiber. The first rare-earth element doped optical fiber includes a first region including a center of a first core configured to guide signal light, a second region surrounding the first region, and a third region surrounding the second region. The second region is doped with a rare-earth element. The second rare-earth element doped optical fiber is provided on a signal output-side of the first rare-earth element doped optical fiber. The second rare-earth element doped optical fiber includes a fourth region including a center of a second core configured to guide the signal light, a fifth region surrounding the fourth region, and a sixth region surrounding the fifth region. The fourth region is doped with the rare-earth element.

In the optical fiber amplifier of the present disclosure, after signal light is amplified by a first rare-earth element doped optical fiber, the signal light is further amplified by a second rare-earth element doped optical fiber. With this arrangement, power efficiency can be increased and noise figure can be reduced.

(2) In (1) above, in a first rare-earth element doped optical fiber, a concentration of a rare-earth element in a first region may be less than or equal to a concentration of the rare-earth element in a second region. With this arrangement, the influence of the first region can be suppressed when the optical fiber amplifier amplifies signal light.

(3) In (1) or (2) above, in a first rare-earth element doped optical fiber, a concentration of a rare-earth element in a first region may be 10% or less a concentration of the rare-earth element in a second region. With this arrangement, the influence of the first region can be suppressed when an optical fiber amplifier amplifies signal light.

(4) In any one of (1) to (3) above, in a second rare-earth element doped optical fiber, a concentration of a rare-earth element in a fourth region may be less than or equal to a concentration of the rare-earth element in a fifth region. With this arrangement, the influence of the fifth region can be suppressed when an optical fiber amplifier amplifies signal light.

(5) In any one of (1) to (4) above, in a second rare-earth element doped optical fiber, a concentration of a rare-earth element in a fifth region may be 10% or less a concentration of the rare-earth element in a fourth region. With this arrangement, the influence of a fifth region can be suppressed when the optical fiber amplifier amplifies signal light.

(6) In any one of (1) to (5) above, a first region in a first rare-earth element doped optical fiber may be a circular region centered around a center of a first core included in a first region. Also, a fourth region of a second rare-earth element doped optical fiber may be a circular region centered around a center of a second core included in a fourth region. Further, a diameter of the first region may be greater than a diameter of the fourth region. With this arrangement, when an optical fiber amplifier amplifies signal light, light can be amplified in respective different regions in the first rare-earth element doped optical fiber and the second rare-earth element doped optical fiber.

(7) In any one of (1) to (6) above, each of a first rare-earth element doped optical fiber and a second rare-earth element doped optical fiber may satisfy a single mode condition in which signal light is transmitted in single mode at an operational wavelength. When the single mode condition is satisfied at the operational wavelength, an optical fiber amplifier can be used in long haul optical communications.

(8) In any one of (1) to (7) above, a first rare-earth element doped optical fiber has a first mode field diameter at an operational wavelength, a second rare-earth element doped optical fiber has a second mode field diameter at an operational wavelength, and the first mode field diameter and the second mode field diameter may be matched within a relative error range of 15% or less. When the first mode field diameter and the second mode field diameter are matched within the relative error range of 15% or less, splice loss can be reduced.

(9) In any one of (1) to (8) above, each of a first rare-earth element doped optical fiber and a second rare-earth element doped optical fiber may be a multicore optical fiber. When each of the first rare-earth element doped optical fiber and the second rare-earth element doped optical fiber is the multicore optical fiber, an optical fiber amplifier can amplify light that is received from the multicore optical fiber.

(10) A rare-earth element doped multicore optical fiber in the present disclosure includes multiple cores each of which is configured to guide signal light, each core of the multiple cores including a first region including a center of the core, and a second region surrounding the first region. Also, the rare-earth element doped multicore optical fiber in the present disclosure includes a third region surrounding all second regions. Further, in the rare-earth element doped multicore optical fiber in the present disclosure, a concentration of a rare-earth element in the first region is less than a concentration of the rare-earth element in the second region.

In the rare-earth element doped multicore optical fiber of the present disclosure, power efficiency can be increased and noise figure can be reduced.

(11) In (10) above, in a rare-earth element doped multicore optical fiber, a concentration of a rare-earth element in a first region may be 20% or less a concentration of the rare-earth element in a second region. When the concentration of the rare-earth element in the first region is 20% or less the concentration of the rare-earth element in the second region, the influence of the first region can be suppressed.

(12) In (9) above, a first rare-earth element doped optical fiber may be a rare-earth element doped multicore optical fiber described in (10) or (11) above.

In an optical fiber amplifier disclosed in (12) above, power efficiency can be increased and noise figure can be reduced.

### Details of Embodiments of the Present Disclosure

Specific examples of an optical fiber amplifier of the present disclosure will be described below with reference to the drawings. The present disclosure is not limited to these examples. Various modifications, omissions, substitutions, and changes in the embodiments are intended to cover the scope of and the equivalent to the present disclosure.

In embodiments in the specification and the drawings, components having substantially the same or corresponding functions are denoted by the same numerals, and redundant description may be omitted. In addition, for ease of understanding, the scale of each component in the drawings may be different from an actual scale.

The embodiments will be described as follows. At least any portion of one or more embodiments described below may be combined with any other embodiment.

### First Embodiment

An optical fiber amplifier according to a first embodiment will be described below. The optical fiber amplifier according to the first embodiment includes a first rare-earth element doped optical fiber and a second rare-earth element doped optical fiber that is provided on a signal output-side of the first rare-earth element doped optical fiber. In the optical fiber amplifier according to the first embodiment, the concentration distribution of a rare-earth element in a cross-section perpendicular to a longitudinal direction of the second rare-earth element doped optical fiber is different from the concentration distribution of the rare-earth element in a cross-section perpendicular to a longitudinal direction of the first rare-earth element doped optical fiber. In the optical fiber amplifier according to the first embodiment, a single-core optical fiber is used for each of the first rare-earth element doped optical fiber and the second rare-earth element doped optical fiber. For example, when the optical fiber amplifier is used in long haul optical communications, each of the first rare-earth element doped optical fiber and the second rare-earth element doped optical fiber may satisfy a single mode condition in which signal light is transmitted in single mode at an operation wavelength.

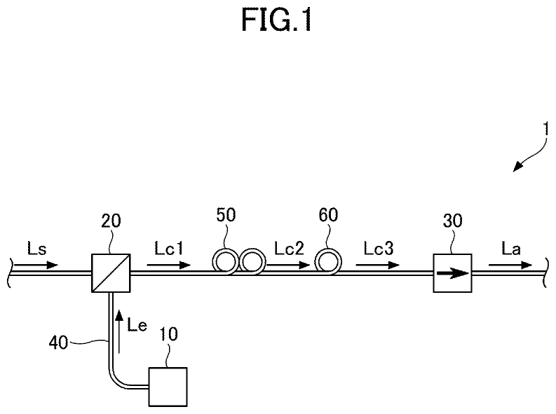

The optical fiber amplifier according to the first embodiment will be described below using a specific example. FIG. 1 is a diagram schematically showing an optical fiber amplifier 1 as an example of the optical fiber amplifier according to the first embodiment. In the optical fiber amplifier 1, an erbium doped optical fiber (EDF) in which an optical fiber is doped with erbium (Er) is used as each of the first rare-earth element doped optical fiber and the second rare-earth element doped optical fiber. The optical fiber amplifier 1 amplifies signal light Ls, and outputs the amplified signal light Ls as signal light La. The optical fiber amplifier 1 includes a pump light source 10, an optical combiner 20, an optical isolator 30, an EDF 50, and an EDF 60. The EDF 50 and the EDF 60 are provided between the optical combiner 20 and the optical isolator 30. The EDF 60 is provided on an output side of the EDF 50.

A mode field diameter of the EDF 50 at an operational wavelength and a mode field diameter of the EDF 60 at an operational wavelength are matched within a relative error range of 15% or less. When the mode field diameter of the EDF 50 at the operational wavelength and the mode field diameter of the EDF 60 at the operational wavelength are matched within the relative error range of 15% or less, splice loss can be suppressed to 0.1 dB or less.

The signal light Ls to be amplified by the optical fiber amplifier 1 is input to the optical combiner 20. The pump light source 10 is connected to the optical combiner 20 via a pump delivery fiber 40. Pump light Le that is output from the pump light source 10 is combined with the signal light Ls in the optical combiner 20. The optical combiner 20 outputs combined light Lc1 that is obtained by combining the signal light Ls and the pump light Le, to the EDF 50. The EDF 50 amplifies the signal light Ls that is included in the input combined light Lc1. Then, the EDF 50 outputs combined light Lc2 to the EDF 60. The EDF 60 amplifies the signal light Ls included in the input combined light Lc2. The EDF 60 outputs combined light Lc3 to the optical isolator 30. The combined light Lc3 that passes through the optical isolator 30 is output as signal light La.

Hereinafter, the first rare-earth element doped optical fiber in the optical fiber amplifier according to the first embodiment will be described.

The first rare-earth element doped optical fiber includes a first region with a center of a core for guiding the signal light, a second region that surrounds the first region, and a third region that surrounds the second region. In the first rare-earth element doped optical fiber, the second region is doped with a rare-earth element. Both the first region and the second region may be doped with the rare-earth element.

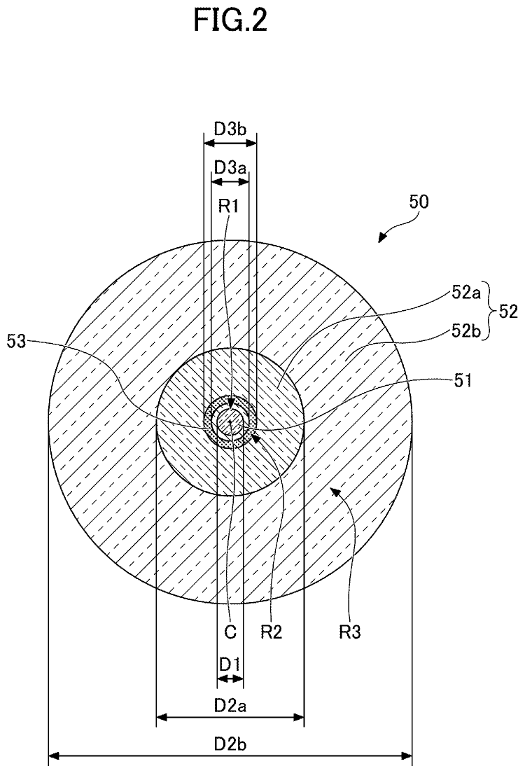

The first rare-earth element doped optical fiber in the optical fiber amplifier according to the first embodiment will be described below using a specific example. FIG. 2 is a diagram showing a schematic structure of the EDF 50 in the optical fiber amplifier 1 as an example of the optical fiber amplifier according to the first embodiment. FIG. 2 is a cross-sectional view of the EDF 50 taken along a plane perpendicular to a longitudinal direction of the EDF 50.

The EDF 50 includes a core 51 and a cladding 52. The cladding 52 includes a first cladding 52a and a second cladding 52b. The EDF 50 has a waveguide structure that is used for the signal light Ls and is constituted by the core 51 and the first cladding 52a. The EDF 50 also has a waveguide structure that is used for the pump light Le and is constituted by the first cladding 52a and the second cladding 52b. In the EDF 50, an annular region of the first cladding 52a, defined by two concentric circles whose centers coincide with the center of the core 51, is doped with erbium. In FIG. 2, an erbium doped region 53 in which the annular region is doped with erbium is indicated by a dotted pattern.

An EDF including an annular region doped with erbium, such as the EDF 50, may be referred to as an optical fiber with an erbium doped annular region.

The core 51 is formed of silica glass co-doped with germanium and aluminum. In the core 51, by co-doping the silica glass with germanium and aluminum, a refractive index of the core 51 is 0.9% greater than that of pure silica glass. A diameter D1 of the core 51 is, for example, 8.9 μm.

The first cladding 52a is formed of silica glass doped with aluminum. In the first cladding 52a, by doping the silica glass with aluminum, a refraction index of the first cladding 52a is 0.5% greater than that of pure silica glass. A diameter D2a of the first cladding 52a is, for example, 50 μm.

The second cladding 52b is formed of silica glass doped with fluorine. In the second cladding 52b, by doping the silica glass with fluorine, a refraction index of the second cladding 52b is 0.7% less than that of pure silica glass. A diameter D2b of the second cladding 52b is, for example, 125 μm.

An inner diameter D3a of the erbium doped region 53 in which the first cladding 52a is doped with erbium is, for example, 14.2 μm. An outer diameter D3b of the erbium doped region 53 is, for example, 17.7 μm. In the erbium doped region 53, the first cladding 52a is doped with erbium having an atomic concentration of about 5×10²⁴ m⁻³.

When the diameter D1 of the core 51 is used as a reference, the inner diameter D3a of the erbium doped region 53 is greater than or equal to 0.4×D1 and less than or equal to 1.8×D1, preferably greater than or equal to 0.8×D1 and less than or equal to 1.4×D1. When the diameter D1 of the core 51 is used as the reference, the outer diameter D3b of the erbium doped region 53 is greater than or equal to 0.8×D1 and less than or equal to 3.0×D1, preferably greater than or equal to 1.0×D1 and less than or equal to 2.0×D1.

In the EDF 50, an inward region from the inner diameter of the erbium doped region 53, which is annular, is referred to as a first region R1. The erbium doped region 53 is referred to as a second region R2. Further, a region that is outward from the outer circumference of the annular erbium doped region 53 is referred to as a third region R3.

In the above example, the second region R2 is doped with the rare-earth element, but both the first region R1 and the second region R2 may be doped with the rare-earth element. For example, a concentration of erbium, which is the rare-earth element, in the first region R1 may be less than or equal to a concentration of erbium, which is the rare-earth element, in the second region. When the concentration of erbium, which is the rare-earth element, in the first region R1 is set to be less than or equal to the concentration of erbium, which is the rare-earth element, in the second region, the signal in the first region R1 is amplified, and thus increases in noise figure in a final output can be suppressed.

Further, the concentration of erbium, which is the rare-earth element, in the first region R1 may be 10% or less the concentration of erbium, which is the rare-earth element, in the second region. When the concentration of erbium, which is the rare-earth element, in the first region R1 is set to be 20% or less, more preferably 10% or less, of the concentration of erbium, which is the rare-earth element, in the second region, the influence of the first region R1 can be suppressed.

Hereinafter, the second rare-earth element doped optical fiber in the optical fiber amplifier according to the first embodiment will be described. The second rare-earth element doped optical fiber includes a fourth region with a center of a core for guiding the signal light, a fifth region that surrounds the fourth region, and a sixth region that surrounds the fifth region. In the second rare-earth element doped optical fiber, the fourth region is doped with a rare-earth element. Both the fourth region and the fifth region may be doped with the rare-earth element.

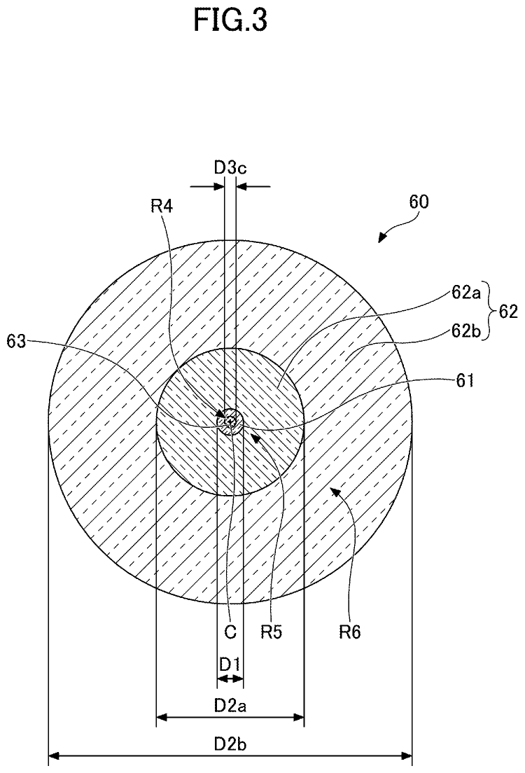

The second rare-earth element doped optical fiber in the optical fiber amplifier according to the first embodiment will be described below using a specific example. FIG. 3 is a diagram showing a schematic structure of the EDF 60 in the optical fiber amplifier 1 as an example of the optical fiber amplifier according to the first embodiment. FIG. 3 is a cross-sectional view of the EDF 60 taken along a plane perpendicular to the longitudinal direction of the EDF 60.

The EDF 60 includes a core 61 and a cladding 62. The cladding 62 includes a first cladding 62a and a second cladding 62b. The EDF 60 has a waveguide structure that is used for the signal light Ls and that is constituted by the core 61 and the first cladding 62a. The EDF 60 also has a waveguide structure that is used for the pump light Le and is constituted by the first cladding 62a and the second cladding 62b. In the EDF 60, a circular region of the core 61 whose center coincides with the center of the core 61 is doped with erbium. In FIG. 3, an erbium doped region 63 in which the circular region is doped with erbium is indicated by a dotted pattern.

An EDF including a circular region doped with erbium, such as the EDF 60, may be referred to as an optical fiber with an erbium doped circular region.

The core 61 is formed of silica glass co-doped with germanium and aluminum. In the core 61, by co-doping the silica glass with the germanium and the aluminum, a refractive index of the core 61 is 0.9% greater than that of pure silica glass. A diameter D1 of the core 61 is, for example, 8.9 μm.

The first cladding 62a is formed of silica glass doped with aluminum. In the first cladding 62a, by doping the silica glass with aluminum, a refraction index of the first cladding 62a is 0.5% greater than that of pure silica glass. A diameter D2a of the first cladding 62a is, for example, 50 μm.

The second cladding 62b is formed of silica glass doped with fluorine. In the second cladding 62b, by doping the silica glass with fluorine, a refraction index of the second cladding 62b is 0.7% less than that of pure silica glass. A diameter D2b of the second cladding 62b is, for example, 125 μm.

A diameter D3c of the erbium doped region 63 in which the core 61 is doped with erbium is, for example, 3.4 μm. In the erbium doped region 63, the core 61 is doped with erbium having an atomic concentration of about 5×1024 m⁻³.

When the diameter D1 of the core 61 is used as a reference, the diameter D3c of the erbium doped region 63 is, for example, greater than or equal to 0.2×D1 and less than or equal to 1.0×D1, preferably greater than or equal to 0.4×D1 and less than or equal to 0.6×D1.

In the EDF 60, the erbium doped region 63 is referred to as a fourth region R4. A region that is disposed outside the erbium doped region 63 and inside the second cladding 62b is referred to as a fifth region R5. Further, a region of the second cladding 62b is referred to as a sixth region R6.

In the optical fiber amplifier 1, the first region R1 is a circular region centered around the center C of the core 51. When the circular region is centered around the center of a given core, it is not limited to a case where the center of the circular region exactly coincides with the center of the given core. For example, even when a center position of the circular region and a center position of the core do not coincide with each other, a case where the above two center positions are within the range of a stated manufacturing tolerance means the case where the circular region is centered around the center of the core. In other words, a case where the center of the circular region is situated in proximity to the center of the core also means the case where the circular region is centered around the center of the core. In the optical fiber amplifier 1, the fourth region R4 is a circular region centered around the center C of the core 61.

The first region R1 and the fourth region R4 are concentric with each of the core 51 and the core 61. When the first region R1 and the fourth region R4 are concentric with each of the core 51 and the core 61, the light can be uniformly amplified.

Further, a radius (inner diameter D3a/2) of the first region R1 is greater than a radius (diameter D3c/2) of the fourth region R4. When the radius (inner diameter D3a/2) of the first region R1 is set to be greater than the radius (diameter D3c/2) of the fourth region R4, a size of the region where the light is amplified in the first rare-earth element doped optical fiber can be set to be different from a size of the region where the light is amplified in the second rare-earth element doped optical fiber.

In the example described above, the fourth region R4 is doped with the rare-earth element, but the fifth region R5 may be doped with the rare-earth element together with the fourth region R4. For example, a concentration of erbium, which is a rare-earth element, in the fifth region R5 may be less than or equal to a concentration of erbium, which is the rare-earth element, in the fourth region R4. When the concentration of erbium, which is the rare-earth element, in the fifth region R5 is set to be less than or equal to the concentration of erbium, which is the rare-earth element, in the fourth region R4, an amplification factor can be increased in the erbium doped region.

Further, the concentration of erbium, which is the rare-earth element, in the fifth region R5 may be 20% or less, preferably 10% or less, of the concentration of erbium, which is the rare-earth element, in the fourth region R4. When the concentration of erbium, which is a rare-earth element, in the fifth region R5 is set to be 10% or less the concentration of erbium, which is the rare-earth element, in the fourth region R4, the influence of the fifth region R5 can be suppressed.

### <Evaluation Result>

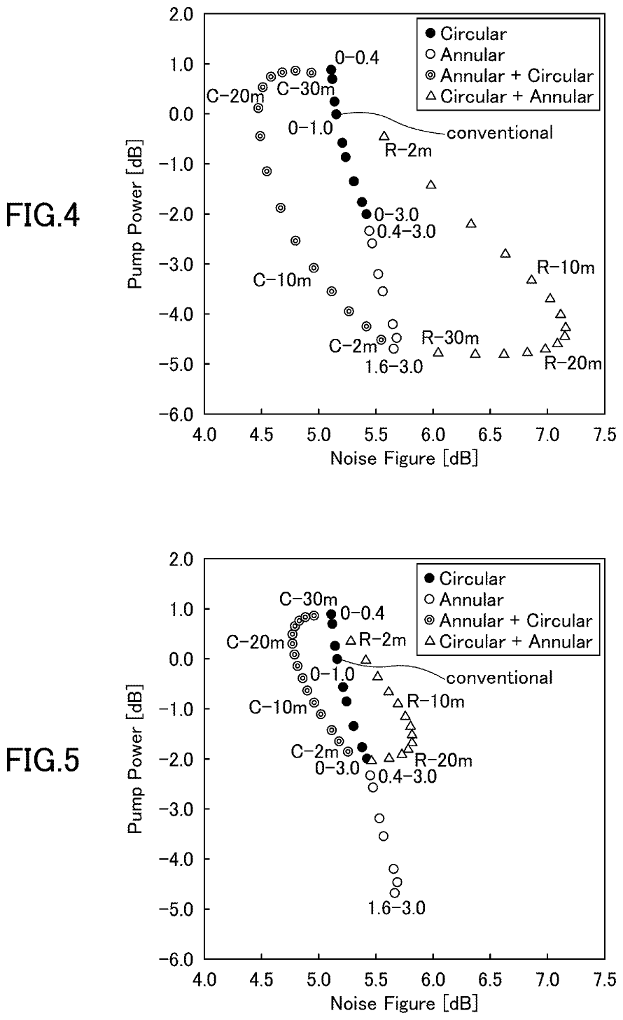

FIG. 4 shows the simulation result of the relationship between noise figure and optical pump power, with respect to (i) EDFs having different erbium doped region shapes and (ii) EDFs combining these different erbium doped region shapes. In FIG. 4, the horizontal axis represents the noise figure, and the vertical axis represents the optical pump power. The relationship between the noise figure and the optical pump power is indicated by black circles (“●”), where the relationship is obtained when a circular region whose center corresponds to a core center is doped with erbium, and a diameter of the doped circular region is changed from 0.4 times to 3.0 times a core diameter. Also, the relationship between the noise figure and the optical pump power is indicated by white circles (“∘”), where the relationship is obtained when an annular region whose center corresponds to the core center is doped with erbium under a condition in which (i) an outer diameter of the doped annular region is constantly 3.0 times the core diameter and (ii) an inner diameter of the doped annular region is changed from 0.4 times to 1.6 times the core diameter.

The relationship between the noise figure and the optical pump power is indicated by double circles (“⊚”), where an optical fiber with an erbium doped annular region (whose inner diameter is 1.6 times a core diameter and outer diameter is 3.0 times the core diameter) is connected to an input side, and an optical fiber with an erbium doped circular region (whose diameter is 0.4 times the core diameter) is connected to an output side. In this arrangement, the relationship indicated by the double circles is obtained by optimizing a length of the optical fiber with the erbium doped annular region under a condition in which a length of the optical fiber with the erbium doped circular region changes from 2 m to 30 m. Further, the relationship between the noise figure and the optical pump power is indicated by triangles (“A”), where an optical fiber with an erbium doped circular region (whose diameter is 0.4 times the core diameter) is connected to an input side, and an optical fiber with an erbium doped annular region (whose inner diameter is 1.6 times the core diameter and outer diameter is 3.0 times the core diameter) is connected to an output side. In this arrangement, the relationship indicated by the triangles is obtained by optimizing a length of the optical fiber with the erbium doped circular region under a condition in which a length of the optical fiber with the erbium doped annular region changes from 2 m to 30 m.

From the result shown in FIG. 4, it has been seen that there is a trade-off between the noise figure and the optical pump power in both a case of using the optical fiber with the erbium doped circular region alone (“●”) and a case of using the optical fiber with the erbium doped annular region alone (“∘”). On the other hand, under a condition (“⊚”) in which the optical fiber with the erbium doped annular region is connected to the input side, and the optical fiber with the erbium doped circular region is connected to the output side, there is a trade-off between the noise figure and the optical pump power. However, in comparison to the case of using the above optical fiber alone, a condition in which both the noise figure and the optical pump power are improved is satisfied. Note that under a condition in which the optical fiber with the doped circular region is connected to the input side, and the optical fiber with the doped annular region is connected to the output side, the optical pump power is improved, but the noise figure is greatly deteriorated.

FIG. 5 shows the simulation result of the relationship between the noise figure and the optical pump power, with respect to (i) EDFs each having a different erbium doped region shape in a cross-section perpendicular to the longitudinal direction of the EDF and (ii) EDFs combining different erbium doped region shapes. In FIG. 5, the horizontal axis represents the noise figure, and the vertical axis represents the optical pump power. The above relationship between the noise figure and the optical pump power is obtained with regard to the four items below.

(1) The relationship between the noise figure and the optical pump power is indicated by black circles (“●”), where the relationship is obtained when a circular region whose center corresponds to a core center is doped with erbium, and a diameter of the doped circular region is changed from 0.4 times to 3.0 times a core diameter.

(2) The relationship between the noise figure and the optical pump power is indicated by white circles (“∘”), where the relationship is obtained when an annular region whose center corresponds to a core center is doped with erbium under a condition in which (i) an outer diameter of the doped annular region is constantly 3.0 times a core diameter and (ii) an inner diameter of the doped annular region is changed from 0.4 times to 1.6 times the core diameter.

(3) The relationship between the noise figure and the optical pump power is indicated by double circles (“⊚”), where an optical fiber with an erbium doped annular region (whose inner diameter is 1.0 times a core diameter and outer diameter is 1.2 times the core diameter) is connected to an input side, and an optical fiber with an erbium doped circular region (whose diameter is 0.4 times the core diameter) is connected to an output side. In this arrangement, the relationship indicated by the double circles is obtained by optimizing a length of the optical fiber with the erbium doped annular region under a condition in which a length of the optical fiber with the erbium doped circular region changes from 2 m to 30 m.

(4) The relationship between the noise figure and the optical pump power is indicated by triangles (“Δ”), where an optical fiber with an erbium doped circular region (whose diameter is 0.4 times a core diameter) is connected to an input side, and an optical fiber with an erbium doped annular region (whose inner diameter is 1.0 times the core diameter and outer diameter is 1.2 times the core diameter) is connected to an output side. In this arrangement, the relationship indicated by the triangles is obtained by optimizing a length of the optical fiber with the erbium doped circular region under a condition in which a length of the optical fiber with the erbium doped annular region changes from 2 m to 26 m.

From the result shown in FIG. 5, there is a trade-off between the noise figure and the optical pump power in a case (“⊚”) where the optical fiber with the doped annular region is connected to the input side and the optical fiber with the doped circular region is connected to the output side. However, in comparison to the case of using the above optical fiber alone, a condition in which both the noise figure and the optical pump power are improved is satisfied.

In the optical fiber amplifier according to the first embodiment, after the signal is amplified by the optical fiber with the doped annular region, the resulting signal is amplified by the optical fiber with the doped circular region. With this arrangement, power efficiency can be increased, and the noise figure can be reduced.

The optical fiber amplifier 1, which is an example of the optical fiber amplifier according to the first embodiment, includes a rare-earth element doped optical fiber in which each optical fiber is doped with erbium as a rare-earth element. However, the rare-earth element used in the rare-earth element doped optical fiber is not limited to the above example. The rare-earth element may include, for example, ytterbium (Yb), neodymium (Nd), or thulium (Tm). These rare-earth elements may be adopted in the following embodiments.

### Second Embodiment

Hereinafter, the optical fiber amplifier according to a second embodiment will be described. The optical fiber amplifier according to the second embodiment uses a multicore optical fiber for each of the first rare-earth element doped optical fiber and the second rare-earth-doped optical fiber.

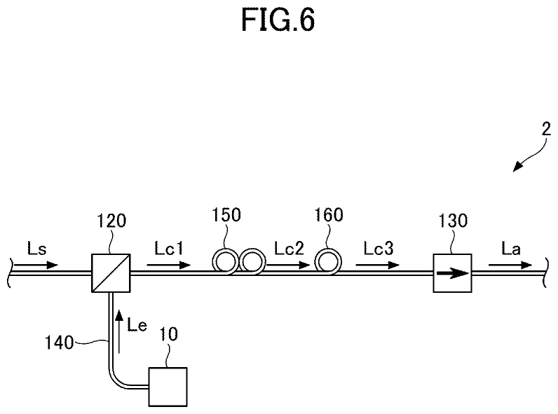

The optical fiber amplifier according to the second embodiment will be described below using a specific example. FIG. 6 is a diagram schematically showing an optical fiber amplifier 2 as an example of the optical fiber amplifier according to the second embodiment. The optical fiber amplifier 2 is a four-core optical fiber amplifier. In the optical fiber amplifier 2, an erbium (Er) doped EDF is used as each of the first rare-earth element doped optical fiber and the second rare-earth element doped optical fiber.

The optical fiber amplifier 2 amplifies signal light Ls, and outputs the amplified signal light Ls as signal light La. The optical fiber amplifier 2 includes the pump light source 10, an optical combiner 120, an optical isolator 130, an EDF 150, and an EDF 160. The EDF 150 and the EDF 160 are provided between the optical combiner 120 and the optical isolator 130. The EDF 160 is provided on an output side of the EDF 150.

The signal light Ls to be amplified by the optical fiber amplifier 2 is input to the optical combiner 120. The pump light source 10 is connected to the optical combiner 120 via a pump delivery fiber 140. The pump light Le output from the pump light source 10 is combined with the signal light Ls in the optical combiner 120. The optical combiner 120 outputs combined light Lc1 that is obtained by combining the signal light Ls and the pump light Le, to the EDF 150. The EDF 150 amplifies the signal light Ls included in the input combined light Lc1. Then, the EDF 150 outputs combined light Lc2 to the EDF 160. The EDF 160 amplifies the signal light Ls included in the input combined light Lc2. Then, the EDF 160 outputs combined light Lc3 to the optical isolator 130. The combined light Lc3 passing through the optical isolator 130 is output as signal light La.

Hereinafter, the first rare-earth element doped optical fiber in the optical fiber amplifier according to the second embodiment will be described. The first rare-earth element doped optical fiber includes first regions each including the center of a corresponding core for guiding the signal light, a second region that surrounds the first regions, and a third region that surrounds the second region. In the first rare-earth element doped optical fiber, the second region is doped with a rare-earth element. Both the first region and the second region may be doped with the rare-earth element.

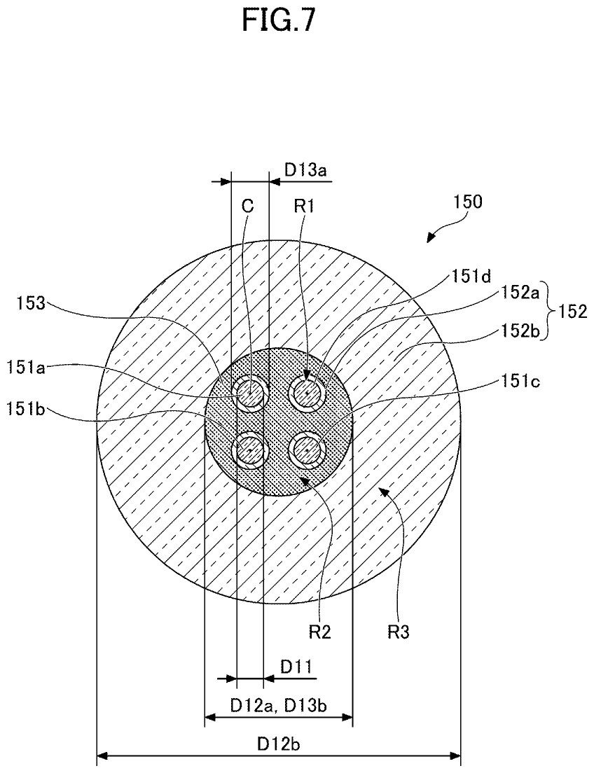

The first rare-earth element doped optical fiber in the optical fiber amplifier according to the second embodiment will be described below using a specific example. FIG. 7 is a diagram showing the schematic structure of the EDF 150 in the optical fiber amplifier 2 as an example of the optical fiber amplifier according to the second embodiment. FIG. 7 is a cross-sectional view of the EDF 150 taken along a plane perpendicular to the longitudinal direction of the EDF 150.

The EDF 150 includes a core 151a, a core 151b, a core 151c, a core 151d, and a cladding 152. The cladding 152 includes a first cladding 152a and a second cladding 152b. The EDF 150 has a waveguide structure that is used for the signal light Ls and is constituted by each core of the core 151a, the core 151b, the core 151c, and the core 151d, and the first cladding 152a. The EFD 150 also has a waveguide structure that is used for the pump light Le and is constituted by the first cladding 152a and the second cladding 152b. In the EDF 150, the first cladding 152a is doped with erbium, except a portion adjacent to each of the core 151a, the core 151b, the core 151c, and the core 151d. In FIG. 7, an erbium doped region 153 in which the first cladding 152a is doped with erbium is indicated by a dotted pattern.

Each of the core 151a, the core 151b, the core 151c, and the core 151d is formed of silica glass co-doped with germanium and aluminum. In each core of the core 151a, the core 151b, the core 151c, and the core 151d, by co-doping the silica glass with germanium and aluminum, a refractive index of the core is 0.9% greater than that of pure silica glass. A diameter D11 of each of the core 151a, the core 151b, the core 151c, and the core 151d is, for example, 8.9 μm.

The core 151a, the core 151b, the core 151c, and the core 151d are arranged in a square grid in which adjacent cores among the cores 151a, 151b, 151c, and 151d are separated, for example, by 25 μm.

The first cladding 152a is formed of silica glass doped with aluminum. In the first cladding 152a, by doping the silica glass with aluminum, a refraction index of the first cladding 152a is 0.5% greater than that of pure silica glass. A diameter D12a of the first cladding 152a is, for example, 50 μm.

The second cladding 152b is formed of silica glass doped with fluorine. In the second cladding 152b, by doping the silica glass with fluorine, a refraction index of the second cladding 152b is 0.7% less than that of pure silica glass. A diameter D12b of the second cladding 152b is, for example, 125 μm.

The erbium doped region 153 in which the first cladding 152a is doped with erbium is formed in the first cladding 152a except a portion of an outer region of each of the core 151a, the core 151b, the core 151c, and the core 151d. The erbium doped region 153 is provided outside each of the core 151a, the core 151b, the core 151c, and the core 151d, and the erbium doped region 153 is away from a center C of each of the core 151a, the core 151b, the core 151c, and the core 151d, by half of the inner diameter D13a. An outer diameter D13b of the erbium doped region 153 is equal to the diameter D12a of the first cladding 152a. An outer diameter D13b of the erbium doped region 153 is, for example, 50 μm. In the erbium doped region 153, the first cladding 152a is doped with erbium having an atomic concentration of about 5×10²⁴ m⁻³.

When the diameter D11 of the core 151a or the like is used as a reference, the inner diameter D13a of the erbium doped region 153 is greater than or equal to 0.4×D11 and less than or equal to 1.8×D11, preferably greater than or equal to 0.8×D11 and less than or equal to 1.4×D11. Also, when the diameter D11 of the core 151a or the like is used as the reference, the outer diameter D13b of the erbium doped region 153 is greater than or equal to 0.8×D11 and less than or equal to 5.0×D11, preferably greater than or equal to 1.0×D11 and less than or equal to 2.0×D11. If a distance from the center of the core 151a or the like is three times or more a radius (half the diameter D11), an optical electric field of the signal light becomes very weak. In view of the above situation, the erbium doped region may be formed within the range of distances that is three times or less the radius (half the diameter D11) from the center of the core 151a or the like.

In the EDF 150, each given region that is inward from the erbium doped annular region 153 is referred to as a first region R1. The erbium doped region 153 is referred to as a second region R2. Further, a region outward from the erbium doped region 153 is referred to as a third region R3.

Hereinafter, the second rare-earth element doped optical fiber in the optical fiber amplifier according to the second embodiment will be described. The second rare-earth element doped optical fiber includes fourth regions each including the center of a corresponding core for guiding the signal light, a fifth region that surrounds the fourth regions, and a sixth region that surrounds the fifth region. In the second rare-earth element doped optical fiber, each of the fourth regions is doped with a rare-earth element. The fourth regions and the fifth region may be doped with the rare-earth element.

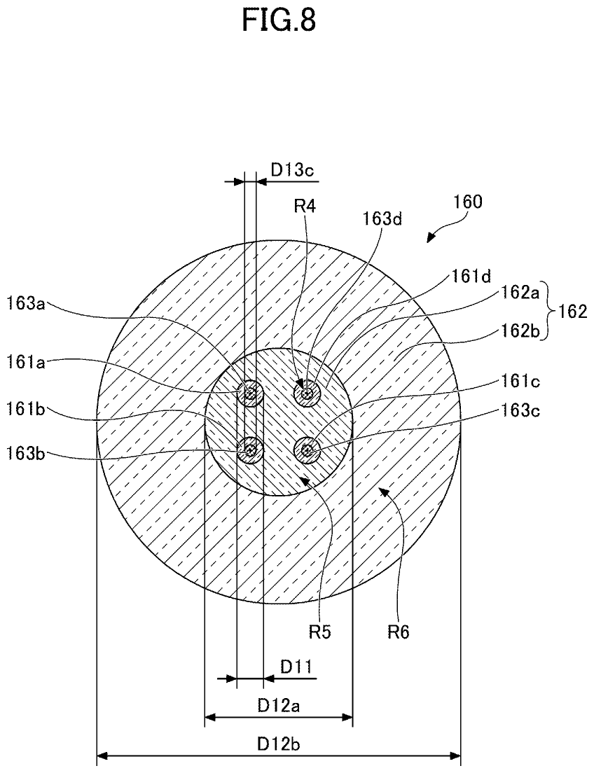

The second rare-earth element doped optical fiber in the optical fiber amplifier according to the second embodiment will be described below using a specific example. FIG. 8 is a diagram showing the schematic structure of the EDF 160 in the optical fiber amplifier 2 as an example of the optical fiber amplifier according to the second embodiment. FIG. 8 is a cross-sectional view of the EDF 160 taken along a plane perpendicular to the longitudinal direction of the EDF 160.

The EDF 160 includes a core 161a, a core 161b, a core 161c, a core 161d, and a cladding 162. The cladding 162 includes a first cladding 162a and a second cladding 162b. The EDF 160 has a waveguide structure that is used for the signal light Ls and is constituted by each core of the core 161a, the core 161b, the core 161c, and the core 161d, and the first cladding 162a. The EDF 160 also has a waveguide structure that is used for the pump light Le and is constituted by the first cladding 162a and the second cladding 162b. In the EDF 160, in each core of the core 161a, the core 161b, the core 161c, and the core 161d, a circular region whose center coincides with the center of the core is doped with erbium. In FIG. 8, an erbium doped region 163a, an erbium doped region 163b, an erbium doped region 163c, and an erbium doped region 163d, in each of which the core is doped with erbium, are indicated by dot patterns.

Each of the core 161a, the core 161b, the core 161c, and the core 161d is formed of silica glass co-doped with germanium and aluminum. In each core of the core 161a, the core 161b, the core 161c, and the core 161d, by co-doping the silica glass with germanium and aluminum, a refractive index of the core is 0.9% greater than that of pure silica glass. The diameter D11 of each of the core 161a, the core 161b, the core 161c, and the core 161d is, for example, 8.9 μm.

The core 161a, the core 161b, the core 161c, and the core 161d are arranged in a square grid in which adjacent cores among the cores 161a, 161b, 161c, and 161d are separated, for example, by 25 μm.

The first cladding 162a is formed of silica glass doped with aluminum. In the first cladding 162a, by doping the silica glass with aluminum, a refraction index of the first cladding 162a is 0.5% greater than that of pure silica glass. A diameter D12a of the first cladding 162a is, for example, 50 μm.

The second cladding 162b is formed of silica glass doped with fluorine. In the second cladding 162b, by doping the silica glass with fluorine, a refraction index of the second cladding 162b is 0.7% less than that of pure silica glass. A diameter D12b of the second cladding 162b is, for example, 125 μm.

A diameter D13c of each of the erbium doped region 163a, the erbium doped region 163b, the erbium doped region 163c, and the erbium doped region 163d is, for example, 3.4 μm. Further, in each of the erbium doped region 163a, the erbium doped region 163b, the erbium doped region 163c, and the erbium doped region 163d, the core is doped with erbium having an atomic concentration of about 5×1024 m−3.

When the diameter D11 of the core 161a or the like is used as a reference, the diameter D13c of the erbium doped region 163a or the like is greater than or equal to 0.2×D11 and less than or equal to 1.0×D11, preferably greater than or equal to 0.4×D11 and less than or equal to 0.6×D11.

In the EDF 160, each of the erbium doped region 163a, the erbium doped region 163b, the erbium doped region 163c, and the erbium doped region 163d is referred to as a fourth region R4. A region that is outward from the erbium doped region 163a, the erbium doped region 163b, the erbium doped region 163c, and the erbium doped region 163d, and that is inward from the second cladding 162b is referred to as a fifth region R5. Further, a region of the second cladding 162b is referred to as a sixth region R6.

### <Modifications>

The optical fiber amplifier according to a modified second embodiment will be described using a modified optical fiber amplifier 2.

The modified optical fiber amplifier 2 includes an EDF 350 instead of the EDF 150 in the optical fiber amplifier 2. In addition, the modified optical fiber amplifier 2 includes an EDF 360 instead of the EDF 160 in the optical fiber amplifier 2.

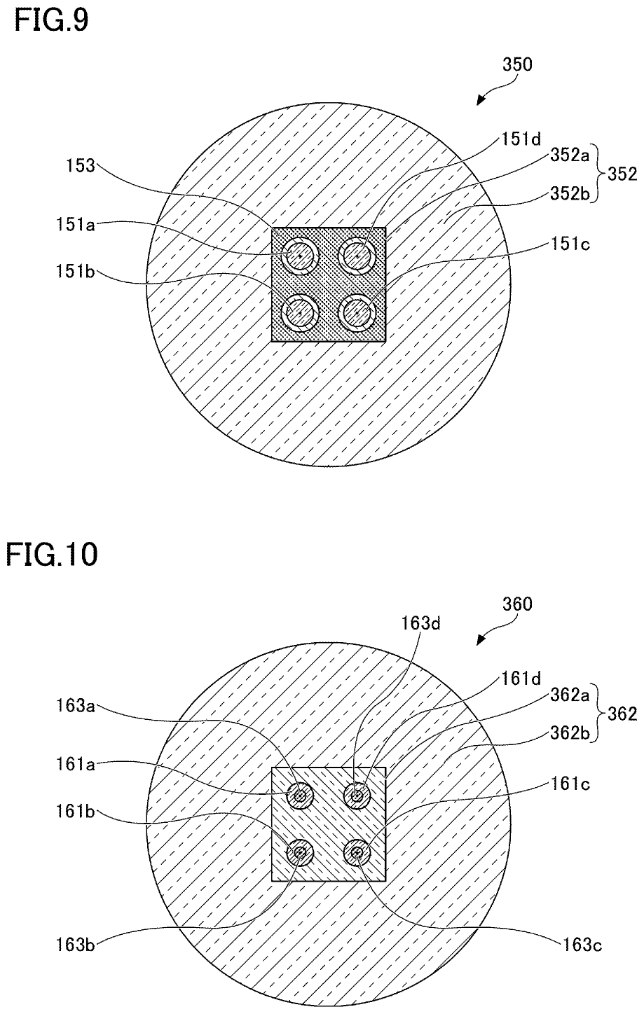

Hereinafter, the first rare-earth element doped optical fiber in the optical fiber amplifier according to the modified second embodiment will be described using a specific example. FIG. 9 is a diagram showing a schematic structure of the EDF 350 of the optical fiber amplifier according to the modified second embodiment. FIG. 9 is a cross-sectional view of the EDF 350 taken along a plane perpendicular to the longitudinal direction of the EDF 350.

The EDF 350 includes a core 151a, a core 151b, a core 151c, a core 151d, and a cladding 352. The cladding 352 includes a first cladding 352a and a second cladding 352b. The EDF 350 has a waveguide structure that is used for the signal light Ls and is constituted by each core of the core 151a, the core 151b, the core 151c, and the core 151d, and the first cladding 352a. The EDF 350 also has a waveguide structure that is used for the pump light Le and is constituted by the first cladding 352a and the second cladding 352b.

In the EDF 350, the first cladding 352a is doped with erbium, except a portion adjacent to each of the core 151a, the core 151b, the core 151c, and the core 151d. In FIG. 9, an erbium doped region 153 in which the first cladding 352a is doped with the erbium is indicated by a dotted pattern. The first cladding 352a has a square shape. Each side of the first cladding 352a is, for example, 40 μm in length.

The second rare-earth element doped optical fiber in the optical fiber amplifier according to the modified second embodiment will be described below using a specific example. FIG. 10 is a diagram showing a schematic structure of the EDF 360 in the optical fiber amplifier according to the modified second embodiment. FIG. 10 is a cross-sectional view of the EDF 360 taken along a plane perpendicular to the longitudinal direction of the EDF 360.

The EDF 360 includes a core 161a, a core 161b, a core 161c, a core 161d, and a cladding 362. The cladding 362 includes a first cladding 362a and a second cladding 362b. The EDF 360 has a waveguide structure that is used for the signal light Ls and is constituted by each core of the core 161a, the core 161b, the core 161c, and the core 161d, and the first cladding 362a. The EDF 360 also has a waveguide structure that is used for the pump light Le and is constituted by the first cladding 362a and the second cladding 362b.

The first cladding 362a has a square shape. Each side of the first cladding 362a is, for example, 40 μm in length.

### Third Embodiment

Hereinafter, the optical fiber amplifier according to a third embodiment will be described. In the optical fiber amplifier according to the third embodiment, a multicore optical fiber is used for each of the first rare-earth element doped optical fiber and the second rare-earth element doped optical fiber.

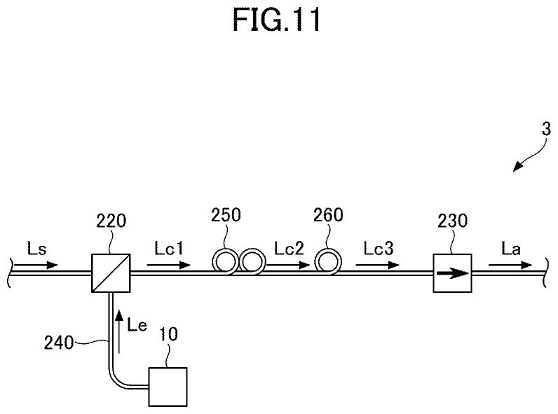

The optical fiber amplifier according to the third embodiment will be described below using a specific example. FIG. 11 is a diagram schematically showing an optical fiber amplifier 3 as an example of the optical fiber amplifier according to the third embodiment. The optical fiber amplifier 3 is a seven-core optical fiber amplifier. In the optical fiber amplifier 3, an erbium (Er) doped EDF is used as each of the first rare-earth element doped optical fiber and the second rare-earth element doped optical fiber.

The optical fiber amplifier 3 amplifies the signal light Ls, and outputs the amplified signal light Ls as signal light La. The optical fiber amplifier 3 includes the pump light source 10, an optical combiner 220, an optical isolator 230, an EDF 250, and an EDF 260. The EDF 250 and the EDF 260 are provided between the optical combiner 220 and the optical isolator 230. The EDF 260 is provided on an output side of the EDF 250.

The signal light Ls to be amplified by the optical fiber amplifier 3 is input to the optical combiner 220. The pump light source 10 is connected to the optical combiner 220 via a pump delivery fiber 240. The pump light Le output from the pump light source 10 is combined with the signal light Ls in the optical combiner 220. The optical combiner 220 outputs combined light Lc1 that is obtained by combining the signal light Ls and the pump light Le, to the EDF 250. The EDF 250 amplifies the signal light Ls included in the input combined light Lc1. Then, the EDF 250 outputs combined light Lc2 to the EDF 260. The EDF 260 amplifies the signal light Ls included in the input combined light Lc2. Then, the EDF 260 outputs combined light Lc3 to the optical isolator 230. The combined light Lc3 that passes through the optical isolator 230 is output as signal light La.

Hereinafter, the first rare-earth element doped optical fiber in the optical fiber amplifier according to the third embodiment will be described. The first rare-earth element doped optical fiber includes first regions each including the center of a corresponding core for guiding the signal light, second regions that surround the respective first regions, and a third region that surrounds the second regions. In the first rare-earth element doped optical fiber, each of the second regions is doped with a rare-earth element. The first regions and the second regions may be doped with the rare-earth element. Each core of multiple cores in the first rare-earth element doped optical fiber includes a first region with the center of the core, and includes a second region surrounding the first region. The first rare-earth element doped optical fiber further includes a third region that surrounds all the second regions. In each core of the multiple cores in the first rare-earth element doped optical fiber, the second region is doped with the rare-earth element. The first regions and the second regions may be doped with the rare-earth element.

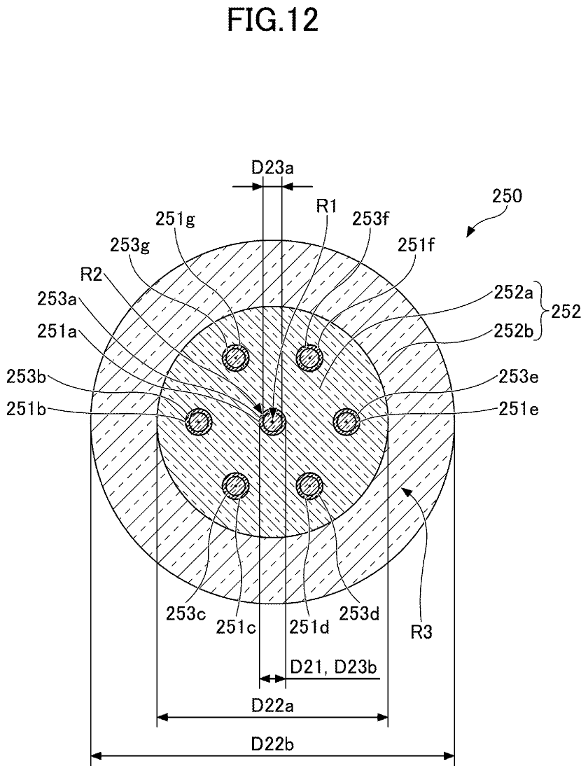

The first rare-earth element doped optical fiber in the optical fiber amplifier according to the third embodiment will be described below using a specific example. FIG. 12 is a diagram showing a schematic structure of the EDF 250 in the optical fiber amplifier 3 as an example of the optical fiber amplifier according to the third embodiment. FIG. 12 is a cross-sectional view of the EDF 250 taken along a plane perpendicular to the longitudinal direction of the EDF 250.

The EDF 250 includes a core 251a, a core 251f, a core 251g, and a cladding 252. In the following description, the core 251a, the core 251b, the core 251c, the core 251d, the core 251e, the core 251f, and the core 251g may be referred to as the core 251a and the like. The cladding 252 includes a first cladding 252a and a second cladding 252b. The EDF 250 has a waveguide structure that is used for the signal light Ls and is constituted by each core of the core 251a and the like, and the first cladding 252a. The EDF 250 also has a waveguide structure that is used for the pump light Le and is constituted by the first cladding 252a and the second cladding 252b.

The core 251a and the like are arranged in a hexagonal close-packed pattern in which adjacent cores among the core 251a and the like are separated, for example, by 25 μm.

In the EDF 250, an annular region in the core 251a is doped with erbium. The core 251a has an erbium doped region 253a. Similarly, the core 251b, the core 251c, the core 251d, the core 251e, the core 251f, and the core 251g include an erbium doped region 253b, an erbium doped region 253c, an erbium doped region 253d, an erbium doped region 253e, an erbium doped region 253f, and an erbium doped region 253g, respectively. In FIG. 12, the erbium doped region 253a and the like in which the cores are doped with erbium are indicated by dotted patterns.

Each core of the core 251a and the like is formed of silica glass co-doped with germanium and aluminum. In each core of the core 251a and the like, by co-doping the silica glass with the germanium and the aluminum, a refraction index of the core is 0.9% greater than that of pure silica glass. A diameter D21 of each core of the core 251a and the like is, for example, 8.9 μm.

The first cladding 252a is formed of silica glass doped with aluminum. In the first cladding 252a, by doping the silica glass with the aluminum, a refraction index of the first cladding 252a is 0.5% greater than that of pure silica glass. A diameter D22a of the first cladding 252a is, for example, 80 μm.

The second cladding 252b is formed of silica glass doped with fluorine. In the second cladding 252b, by doping the silica glass with fluoride, a refraction index of the second cladding 252b is 0.7% less than that of pure silica glass. A diameter D22b of the second cladding 252b is, for example, 125 μm.

In the core 251a, an inner diameter D23a of the erbium doped region 253a is, for example, 7.0 μm. Also, an outer diameter D23b of the erbium doped region 253a in the core 251a is equal to the diameter D21 of the core 251a. An outer diameter D23b of the erbium doped region 253a in the core 251a is, for example, 8.9 μm. In the erbium doped region 253a in which the core 251a is doped with erbium, the core 251a is doped with erbium having an atomic concentration of about 4×10²⁴ m⁻³. In the other erbium doped regions including the erbium doped region 253b and the like, doping is performed as in the erbium doped region 253a.

When the diameter D21 of each core of the core 251a and the like is used as a reference, the inner diameter D23a of each erbium doped region of the erbium doped region 253a and the like is greater than or equal to 0.4×D21 and less than or equal to 1.8×D21, preferably greater than or equal to 0.8×D21 and less than or equal to 1.4×D21. Also, when the diameter D21 of each core of the core 251a and the like is used as the reference, the outer diameter D23b of each erbium doped region of the erbium doped region 253a and the like is greater than or equal to 0.8×D21 and less than or equal to 5.0×D21, preferably greater than or equal to 1.0×D21 and less than or equal to 2.0×D21.

In the EDF 250, a region that is inward relative to each annular erbium doped region of the annular erbium doped region 253a and the like is referred to as a first region R1. Each annular erbium doped region of the erbium doped region 253a and the like is referred to as a second region R2. Further, a region that is outside the erbium doped region 253a and the like is referred to as a third region R3.

Hereinafter, the second rare-earth element doped optical fiber in the optical fiber amplifier according to the third embodiment will be described. The second rare-earth element doped optical fiber includes fourth regions each including the center of a corresponding core for guiding the signal light, a fifth region that surrounds the fourth regions, and a sixth region that surrounds the fifth region. In the second rare-earth element doped optical fiber, each of the fourth regions is doped with a rare-earth element. The fourth regions and the fifth region may be doped with the rare-earth element.

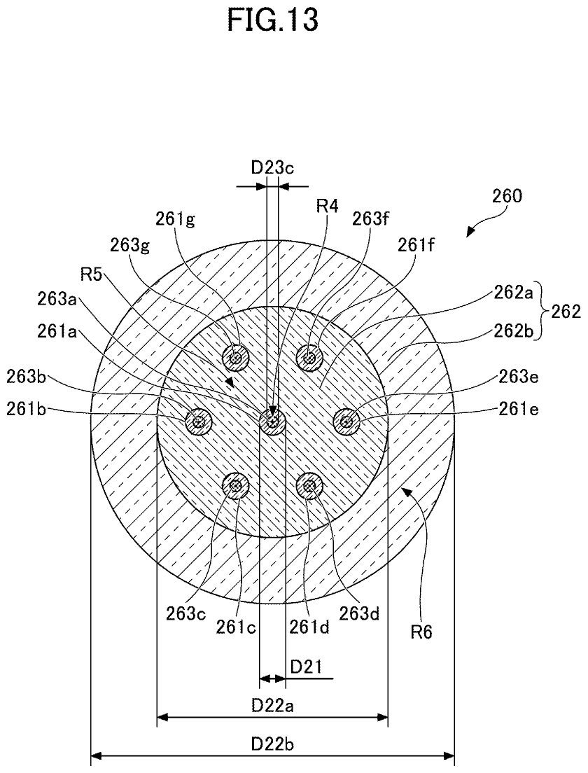

The second rare-earth element doped optical fiber in the optical fiber amplifier according to the third embodiment will be described below using a specific example. FIG. 13 is a diagram showing a schematic structure of the EDF 260 in the optical fiber amplifier 3 as an example of the optical fiber amplifier according to the third embodiment. FIG. 13 is a cross-sectional view of the EDF 260 taken along a plane perpendicular to the longitudinal direction of the EDF 260.

The EDF 260 includes a core 261a, a core 261b, a core 261c, a core 261d, a core 261e, a core 261f, a core 261g, and a cladding 262. In the following description, the core 261a, the core 261b, the core 261c, the core 261d, the core 261e, the core 261f, and the core 261g may be referred to as the core 261a and the like. The cladding 262 includes a first cladding 262a and a second cladding 262b. The EDF 260 has a waveguide structure that is used for the signal light Ls and is constituted by each core of the core 261a and the like, and the first cladding 262a. The EDF 260 also has a waveguide structure that is used for the pump light Le and is constituted by the first cladding 262a and the second cladding 262b.

In the EDF 260, a circular region in the core 261a is doped with erbium. The core 261a has an erbium doped region 263a. Similarly, the core 261b, the core 261c, the core 261d, the core 261e, the core 261f, and the core 261g have an erbium doped region 263b, an erbium doped region 263c, an erbium doped region 263d, an erbium doped region 263e, an erbium doped region 263f, and an erbium doped region 263g, respectively. In FIG. 13, the erbium doped region 263a and the like are shown by dotted patterns.

Each core of the core 261a and the like is formed of silica glass co-doped with germanium and aluminum. In each core of the core 261a and the like, by co-doping the silica glass with germanium and aluminum, a refraction index of the core is 0.9% greater than that of pure silica glass. A diameter D21 of each core of the core 261a and the like is, for example, 8.9 μm.

The cores including the core 261a and the like are arranged in a hexagonal close-packed pattern in which adjacent cores among the cores are separated, for example, by 25 μm.

The first cladding 262a is formed of silica glass doped with aluminum. In the first cladding 262a, by doping the silica glass with aluminum, a refraction index of the first cladding 262a is 0.5% greater than that of pure silica glass. A diameter D22a of the first cladding 262a is, for example, 80 μm.

The second cladding 262b is formed of silica glass doped with fluorine. In the second cladding 262b, by doping the silica glass with fluorine, a refraction index of the second cladding 262b is 0.7% less than that of pure silica glass. A diameter D22b of the second cladding 262b is, for example, 125 μm.

A diameter D23c of the erbium doped region 263a in which the core 261a is doped with erbium is, for example, 3.4 μm. In the erbium doped region 263a, the core 261a is doped with erbium having an atomic concentration of about 4×10²⁴ m⁻³. Doping is performed in the erbium doped region 263b and the like, as in the erbium doped region 263a.

When the diameter D21 of each core of the core 261a and the like is used as a reference, the diameter D23c of each erbium doped region of the erbium doped region 263a and the like is greater than or equal to 0.2×D21 and less than or equal to 1.0×D21, preferably greater than or equal to 0.4×D21 and less than or equal to 0.6×D21.

In the EDF 260, each erbium doped region of the erbium doped region 263a and the like is referred to as a fourth region R4. A region that is outward from the erbium doped region 263a and the like and that is inward from the second cladding 262b is referred to as a fifth region R5. Further, a region of the second cladding 262b is referred to as a sixth region R6.

### <Modifications>

Hereinafter, the optical fiber amplifier according to a modified third embodiment will be described using a modified optical fiber amplifier 3.

The modified optical fiber amplifier 3 includes an EDF 450 instead of the EDF 250 in the optical fiber amplifier 3. In addition, the modified optical fiber amplifier 3 includes an EDF 460 instead of the EDF 260 in the optical fiber amplifier 3.

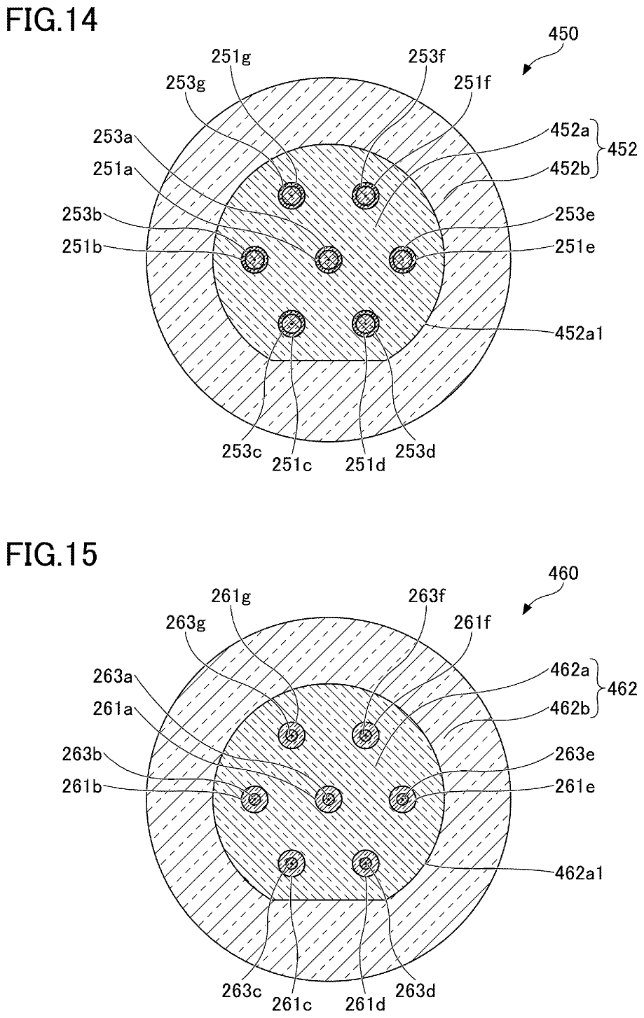

The first rare-earth element doped optical fiber in the optical fiber amplifier according to the modified third embodiment will be described below using a specific example. FIG. 14 is a diagram showing a schematic structure of the EDF 450 in the optical fiber amplifier according to the modified third embodiment. FIG. 14 is a cross-sectional view of the EDF 450 taken along a plane perpendicular to the longitudinal direction of the EDF 450.

The EDF 450 includes a core 251a, a core 251f, a core 251g, and a cladding 452. The cladding 452 includes a first cladding 452a and a second cladding 452b. The EDF 450 has a waveguide structure that is used for the signal light Ls and is constituted by each core of the core 251a and the like, and the first cladding 452a. The EDF 450 also has a waveguide structure that is used for the pump light Le and is constituted by the first cladding 452a and the second cladding 452b.

The first cladding 452a has a cross-sectional shape that is surrounded by an arc (major arc) 452a1, having a central angle of greater than 180°, and a chord 452a2. A diameter of the arc 452al is, for example, 80 μm. The chord 452a2 is, for example, 40 μm in length.

The second rare-earth element doped optical fiber in the optical fiber amplifier according to the modified third embodiment will be described below using a specific example. FIG. 15 is a diagram showing a schematic structure of the EDF 460 in the optical fiber amplifier according to the modified third embodiment. FIG. 15 is a cross-sectional view of the EDF 460 taken along a plane perpendicular to the longitudinal direction of the EDF 460.

The EDF 460 includes a core 261a, a core 261b, a core 261c, a core 261d, a core 261e, a core 261f, a core 261g, and a cladding 462. The cladding 462 includes a first cladding 462a and a second cladding 462b. The EDF 460 has a waveguide structure that is used for the signal light Ls and is constituted by each core of the core 261a and the like, and the first cladding 462a. The EDF 460 also has a waveguide structure that is used for the pump light Le and is constituted by the first cladding 462a and the second cladding 462b.

The first cladding 462a has a cross-sectional shape surrounded by an arc (major arc) 462a1, having a center angle of greater than 180°, and a chord 462a2. A diameter of the arc 462a1 is, for example, 80 μm. The chord 462a2 is, for example, 40 μm in length.

The embodiments of the present disclosure are presented for purposes of illustration, and are not intended to be limiting in all respects. Various modifications, omissions, substitutions, and changes in the embodiments are intended to cover the scope of and the equivalent to the present disclosure.

What is claimed is:

1. An optical fiber amplifier comprising:
a first rare-earth element doped optical fiber including
a first region including a center of a first core configured to guide signal light,
a second region surrounding the first region and doped with a rare-earth element, and
a third region surrounding the second region; and
a second rare-earth element doped optical fiber provided on a signal output-side of the first rare-earth element doped optical fiber, the second rare-earth element doped optical fiber including
a fourth region including a center of a second core configured to guide the signal light, the fourth region being doped with the rare-earth element,
a fifth region surrounding the fourth region, and
a sixth region surrounding the fifth region.

2. The optical fiber amplifier according to claim 1, wherein in the first rare-earth element doped optical fiber, a concentration of the rare-earth element in the first region is less than or equal to a concentration of the rare-earth element in the second region.

3. The optical fiber amplifier according to claim 2, wherein in the first rare-earth element doped optical fiber, the concentration of the rare-earth element in the first region is 10% or less the concentration of the rare-earth element in the second region.

4. The optical fiber amplifier according to claim 1, wherein in the second rare-earth element doped optical fiber, a concentration of the rare-earth element in the fifth region is less than or equal to a concentration of the rare-earth element in the fourth region.

5. The optical fiber amplifier according to claim 4, wherein in the second rare-earth element doped optical fiber, the concentration of the rare-earth element in the fifth region is 10% or less the concentration of the rare-earth element in the fourth region.

6. The optical fiber amplifier according to claim 1, wherein the first region in the first rare-earth element doped optical fiber is a circular region centered around the center of the first core included in the first region,
wherein the fourth region in the second rare-earth element doped optical fiber is a circular region centered around the center of the second core included in the fourth region, and
wherein a diameter of the first region is greater than a diameter of the fourth region.

7. The optical fiber amplifier according to claim 1, wherein each of the first rare-earth element doped optical fiber and the second rare-earth element doped optical fiber satisfies a single mode condition in which the signal light is transmitted in single mode at an operational wavelength.

8. The optical fiber amplifier according to claim 7, wherein the first rare-earth element doped optical fiber has a first mode field diameter at the operational wavelength, and the second rare-earth element doped optical fiber has a second mode field diameter at the operational wavelength, and
wherein the first mode field diameter and the second mode field diameter are matched within a relative error range of 15% or less.

9. The optical fiber amplifier according to claim 1, wherein each of the first rare-earth element doped optical fiber and the second rare-earth element doped optical fiber is a multicore optical fiber.

10. A rare-earth element doped multicore optical fiber comprising:
multiple cores each of which is configured to guide signal light, each core of the multiple cores including
a first region including a center of the core, and
a second region surrounding the first region; and
a third region surrounding all second regions in the multiple cores,
wherein a concentration of a rare-earth element in the first region is less than a concentration of the rare-earth element in the second region.

11. The rare-earth element doped multicore optical fiber according to claim 10, wherein the concentration of the rare-earth element in the first region is 20% or less the concentration of the rare-earth element in the second region.

12. The optical fiber amplifier according to claim 9, wherein the multicore optical fiber of the first rare-earth element doped optical fiber includes
multiple cores each of which is configured to guide signal light, each core of the multiple cores including
the first region including a center of the core, and
the second region surrounding the first region; and
the third region surrounding all second regions in the multiple cores,
wherein a concentration of a rare-earth element in the first region is less than a concentration of the rare-earth element in the second region, and
wherein the concentration of the rare-earth element in the first region is 20% or less the concentration of the rare-earth element in the second region.
